(19) United States
(12) Patent Application Publication
(10) Pub. No.: US 2022/0018658 A1
(43) Pub. Date: Jan. 20, 2022

(54) MEASURING SYSTEM, MEASURING METHOD, AND MEASURING PROGRAM

(71) Applicant: THE UNIVERSITY OF TOKYO, Tokyo (JP)

(72) Inventors: Masahiro HIRANO, Tokyo (JP); Taku SENOO, Tokyo (JP); Norimasa KISHI, Tokyo (JP); Masatoshi ISHIKAWA, Tokyo (JP)

(21) Appl. No.: 17/299,362

(22) PCT Filed: Dec. 11, 2019
(86) PCT No.: PCT/JP2019/048554

§ 371 Date: Jun. 3, 2021

(30) Foreign Application Priority Data
Dec. 12, 2018 (JP) 2018-232784

(51) Int. Cl. G01C 11/26; H04N 5/232; H04N 13/264

(52) U.S. Cl. CPC G01C 11/26; H04N 13/264; H04N 5/23206

(57) ABSTRACT

A measuring system configured to measure a position of an object is provided with an imaging apparatus and an information processing apparatus, wherein: the imaging apparatus is a camera having a frame rate of 100 fps or higher, and is configured to image the object included in the angle of view of the camera, as an image; the information processing apparatus is provided with a communication unit, an IPM conversion unit, and a position measuring unit; the communication unit is connected to the imaging apparatus, and is configured to receive the image captured by the imaging apparatus; the IPM conversion unit is configured to set at least a part of the image including the object as a predetermined area, and to perform an inverse perspective projection transportation of the image to generate an IPM image limited to the predetermined area. Here, the IPM image is an image in which a predetermined area including the object is rendered as seen from overhead; and the position measuring unit is configured to measure the position of the object on the basis of the IPM image.

### CROSS REFERENCE TO RELATED APPLICATIONS

This application is a U.S. National Phase Application under 35 U.S.C. 371 of International Application No. PCT/JP2019/048554, filed on Dec. 11, 2019, which claims priority to Japanese Patent Application No. 2018-232784, filed on Jun. 12, 2021. The entire disclosures of the above applications are expressly incorporated by reference herein.

### BACKGROUND

### Technical Field

The present invention relates to a measurement system, a measurement method, and a measurement program.

### Related Art

In the industrial field, the proper recognition of the surrounding environment by a stationary or moving measurement system is one of the crucial technologies to realize safe operations. In particular, it is necessary to detect the presence of an object (obstacle) quickly and reliably when it enters the field of view of the measurement system. For example, JP 2013-65304 discloses a measurement system for detecting obstacles. The measurement system is configured to perform reverse perspective projection transportation on the images captured by camera, to generate images drawn as an overhead view of a predetermined plan called IPM images, and to detect obstacles from the IPM images.

However, the inverse perspective projection transportation in the measurement system disclosed in JP 2013-65304 requires processing time, resulting in a low operating rate and high latency. As a result, the performance of the system, which is the crucial factor, is not sufficient to ensure safety.

The present invention has been made in view of the above circumstances and provides a measurement system, a measurement method, and a measurement program capable of implementing safe operation in industry by rapidly and reliably detecting the presence of an object (obstacle) to be measured.

### SUMMARY

According to one aspect of the present invention, there is provided a measurement system configured to measure a position of an object, comprising: an imaging apparatus and an information processing apparatus, wherein: the imaging apparatus is a camera with a frame rate, and is configured to capture the object included in an angle of view of the camera as an image; and the information processing apparatus includes: a communication unit, connected to the imaging apparatus, and configured to receive the image captured by the imaging apparatus, an IPM conversion unit, configured to set at least a part of the image including the object as a predetermined area, and to perform inverse perspective projection transportation on the image to generate an IPM image limited to the predetermined area, the IPM image being an image drawn as an overhead view of the predetermined planes including the object, and a position measurement unit configured to measure position of the object based on the IPM image.

In the system of the present invention, an object is captured by a camera with a frame rate of 100 fps or higher, and such image is inverse perspective projection transported to generate an IPM image limited to a predetermined area, which is used to measure the position of the object. By using a camera with a high frame rate of 100 fps or higher, the possible positions of the object are limited, and the processing time for inverse perspective projection transportation and position measurement can be shortened by limiting it to a predetermined area as a precondition. As a result, the drive frequency can be increased and the latency can be reduced to achieve safer operation.

### BRIEF DESCRIPTION OF THE DRAWINGS

FIG. 1 is a functional block diagram of the system according to an embodiment.

FIG. 2 is a schematic view of inverse perspective projection transportation.

FIG. 3A shows a first image captured by a first camera (left), FIG. 3B shows a second image captured by a second camera (right), FIG. 3C shows a first IPM image obtained by converting the first image,

FIG. 3D shows a second IPM image obtained by converting the second image, FIG. 3E shows a difference between the first and second IPM images, and FIG. 3F shows an overhead view captured by another camera (not shown).

FIG. 4A is a first histogram obtained from the difference image in FIG. 3E, and FIG. 4B is a second histogram obtained from the difference image in FIG. 3E.

FIG. 5 is a flowchart showing the flow of a measurement method.

FIGS. 6A and 6B are schematic views showing determination of a predetermined area considering parameters related to the state.

FIG. 7 is a schematic view showing the flow of machine learning.

FIG. 8 is a schematic view showing a relationship between a pitch angle of the camera and movement of feature points on the road surface (optical flow).

FIG. 9 is a schematic view showing a relationship between the pitch angle of the camera and the movement of the feature points on the road surface (optical flow).

FIGS. 10A-10C are figures showing comparison between an optical flow for an image IM before IPM conversion processing (FIG. 10A), an optical flow obtained by a first IPM conversion processing (FIG. 10B), and an optical flow obtained by a second IPM conversion processing (FIG. 10C).

### DETAILED DESCRIPTION OF EMBODIMENTS

Hereinafter, embodiments of the present invention will be described with reference to the drawings. Various features described in the embodiment below can be combined with each other. Especially in the present specification, the “unit” may include, for instance, a combination of hardware resources implemented by circuits in a broad sense and information processing of software that can be concretely realized by these hardware resources. Furthermore, although various information is performed in the present embodiments, these information are represented by high and low signal values as a bit set of binary numbers composed of 0 or 1, and communication/calculation can be executed on a circuit in a broad sense.

Further, a circuit in a broad sense is a circuit realized by at least appropriately combining a circuit, a circuitry, a processor, a memory, and the like. That is, an application special integrated circuit (ASIC), a programmable logic device (for example, a simple programmable logic device (SPLD)), a complex programmable logic device (CLPD), a field programmable gate array (FPGA), and the like.

1. Overall Configuration

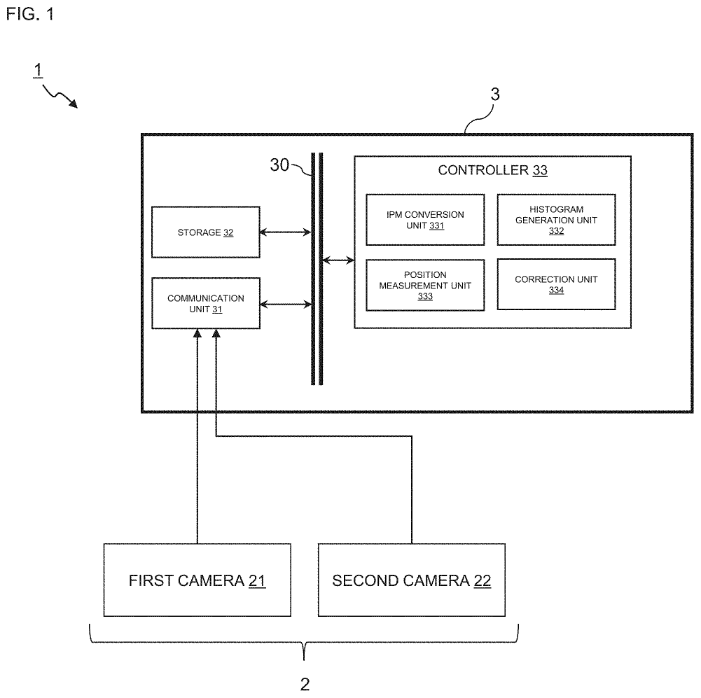

In section 1, the overall configuration of a measurement system 1 will be described. FIG. 1 is a schematic configuration diagram of the measurement system 1 according to the present embodiment. The measurement system 1 comprises an imaging apparatus 2 and an information processing apparatus 3, which are electrically connected to each other. The measurement system 1 may be used stationary, but preferably to be installed on moving means. The moving means is assumed to be, for example, automobile, train (including not only public transportation but also amusement, etc.), ship, flying vehicle (including airplane, helicopter, drone, etc.), mobile robot, etc. In the present specification, an automobile will be used as an example for explanation, and the automobile in which the measurement system 1 is installed will be defined as “the automobile”. In other words, the measurement system 1 is used to measure the position of the automobile, for example, a vehicle (an object that is an obstacle) in front of the automobile.

1.1 Imaging Apparatus 2

The imaging apparatus 2 is a so-called vision sensor (camera) that is configured to acquire external world information as images, and it is particularly preferable that a high frame rate, referred to as high velocity vision, is employed. The frame rate is, for example, 100 fps or higher, preferably 250 fps or higher, and more preferably 500 fps or 1000 fps. Specifically, for example, the frame rate may be 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 8 50, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 15 25, 1550, 1575, 1600, 1625, 1650, 1675, 1700, 1725, 1750, 1775, 1800, 1825, 1850, 1875, 1900, 1925, 1950, 1975, 2000 fps (Hertz), and may be in a range between any two of the numerical values illustrated herein. More specifically, the imaging apparatus 2 is a so-called binocular image capturing device comprises a first camera 21 and a second camera 22. It should be noted that the angle of view of the first camera 21 and the angle of view of the second camera 22 overlap each other in some areas. In the imaging apparatus 2, a camera capable of measuring not only visible light but also bands that humans cannot perceive, such as the ultraviolet and infrared region, may be employed. By employing such a camera, measurement using the measurement system 1 according to the present embodiment enables to be carried out even in a dark field.

<First camera 21>

The first camera 21, for example, is installed in parallel with the second camera 22 in the measurement system 1, and is configured to capture images of the left front side of the automobile. Specifically, a vehicle (an object that is an obstacle) in front of the automobile can be captured in the angle of view of the first camera 21. Further, the first camera 21 is connected to a communication unit 31 of the information processing apparatus 3 as described later by an electric communication line (for instance, USB cable, etc.), and is configured to transfer the captured images to the information processing apparatus 3.

<Second Camera 22>

The second camera 22 is, for example, installed in parallel with the first camera 21 in the measurement system 1, and is configured to capture images of the right front side of the automobile. Specifically, a vehicle (an object that is an obstacle) in front of the automobile can be captured in the angle of view of the second camera 22. Further, the second camera 22 is connected to the communication unit 31 of the information processing apparatus 3 as described later by an electric communication line (for instance, USB cable, etc.), and is configured to transfer the captured images to the information processing apparatus 3.

1.2 Information Processing Apparatus 3

The information processing apparatus 3 includes the communication unit 31, a storage 32, and a controller 33, and these components are electrically connected via a communication bus 30 inside the information processing apparatus 3. Each of the components will be described further below.

<Communication Unit 31>

Although wired communication means such as USB, IEEE1394, Thunderbolt, or wired LAN network communication are preferred for the communication unit 31, wireless LAN network communication, mobile communication such as LTE/3G, Bluetooth (registered trademark) communication, or the like may be included as necessary. In other words, it is more preferable to implement the system as a set of these multiple communication means. In particular, it is preferable that the first camera 21 and the second camera 22 in the imaging apparatus 2 are configured to communicate with each other in a predetermined high velocity communication standard (for example, USB 3.0, Camera Link, etc.). In addition, a monitor (not shown) for displaying measurement results of the a front vehicle and an automatic controller (not shown) for automatically controlling (automatically driving) the automobile based on the measurement results may be connected.

<Storage 32>

The storage 32 stores various information defined by the above-mentioned description. This can be implemented, for example, as a storage device such as a solid state drive (SSD), or as a random access memory (RAM) that temporarily stores necessary information (arguments, arrays, etc.) related to program operations. Further, combinations thereof may be used.

In particular, the storage 32 stores a first image IM1 and a second image IM2 (images IM) captured by the first camera 21 and the second camera 22 in the imaging apparatus 2 and received by the communication unit 31. The storage 32 stores the IPM image IM′. Specifically, the storage 32 stores the first IPM image IM1′ converted from the first image IM1 and the second IPM image IM2′ converted from the second image IM2. Here, the image IM and the IPM image IM′ are array information that comprises, for example, 8 bits each of RGB pixel information.

The storage 32 stores an IPM conversion program for generating an IPM image IM′ based on an image IM. The storage 32 stores a histogram generation program for calculating a difference D of the first IPM image IM1′ and the second IPM image IM2′ and for generating the first histogram HG1 based on the angle (direction) and the second histogram HG2 based on the distance. The storage 32 stores a predetermined area determination program for determining a predetermined area ROI to be used in processing in the next frame based on the first histogram HG1 and the second histogram HG2. The storage 32 stores a position measurement program for measuring a position of the front vehicle based on the difference D. The storage 32 stores a correction program for correcting the error of the IPM image IM′ from the true value. Furthermore, the storage 32 stores various programs related to the measurement system 1 executed by the controller 33 in addition to the above.

<Controller 33>

The controller 33 performs processing and control of the overall operation related to the information processing apparatus 3. The controller 33 is, for example, a central processing unit (CPU) (not shown). The controller 33 realizes various functions related to the information processing apparatus 3 by reading out a predetermined program stored in the storage 32. Specifically, the various functions refer to a IPM conversion function, a histogram generation function, a predetermined area ROI determination function, a position measurement function, a correction function, and the like. That is, information processing by software (stored in the storage 32) can be specifically realized by hardware (controller 33) to be executed as a IPM conversion unit 331, a histogram generation unit 332, a position measurement unit 333, and a correction unit 334. In FIG. 1, although it is described as a single controller 33, in fact it is not limited to this, and may be implemented to have a plurality of controllers 33 for each function. Further, it may also be a combination thereof. Hereinafter, the IPM conversion unit 331, the histogram generation unit 332, the position measurement unit 333, and the correction unit 334 will be described in detail.

[IPM Conversion Unit]

The IPM conversion unit 331 is configured to perform inverse perspective projection conversion processing on images IM transmitted from the first camera 21 and the second camera 22 in the imaging apparatus 2 and received by the communication unit 31. The IPM conversion unit 331 is configured to perform inverse perspective projection conversion processing on the image IM transmitted from the first camera 21 and the second camera 22 in the imaging apparatus 2 and received by the communication unit 31. The inverse perspective projection transportation will be described in detail in Section 2.

In other words, the first IPM image IM1′ is generated by the inverse perspective projection transportation of the first image IM1, and the second IPM image IM2′ is generated by the inverse perspective projection transportation of the second image IM2. Here, as explained in [Problems to be solved by invention], the inverse perspective projection transportation requires processing time. It should be noted that in the measurement system 1 of the present embodiment, the IPM image IM′ corresponding to the entire area of the image IM is not generated, but the IPM image IM′ limited to the predetermined area ROI is generated. That is, by exclusively performing the inverse perspective projection transportation, which inherently requires processing time, the processing time can be reduced, and the control rate of the entire measurement system 1 can be increased. More specifically, for the measurement system 1 as a whole, the lower frame rate of the first camera 21 and the second camera 22 and the lower operation rate of the controller 33 work as the control rate related to the position measurement. In other words, by increasing the frame rate and operation rate to the same level, the measurement (tracking) of the position of the front vehicle can be performed even if only feedback control is employed.

The predetermined area ROI is determined by the processing of the past (usually the last one) frame, and will be described in more detail in Section 3. In other words, assuming that the image related to the n-th (n≥2) frame captured by the imaging apparatus 2 is a current image, and the image related to the n-k-th (n>k≥1) frame captured by the imaging apparatus 2 is a past image, then the predetermined area ROI applied to the current image is set based on the past position of the object measured using the past image.

[Histogram Generation Unit 332]

The histogram generation unit 332 is one in which information processing by software (stored in the storage 32) is concretely realized by hardware (the controller 33). The histogram generation unit 332 calculates the difference D of the first IPM image IM1′ and the second IPM image IM2′, and subsequently generates a plurality of histograms HG generated with respect to different parameters, respectively. Such histograms HG are limited to the predetermined area ROI determined in a past frame. Specifically, a first histogram HG1 based on the angle (direction) and a second histogram HG2 based on the distance are generated. Further, the histogram generation unit 332 determines the predetermined area ROI to be used in the processing in the next frame based on the generated first histogram HG1 and the second histogram HG2. More details will be descried in Section 3.

[Position Measurement Unit 333]

The position measurement unit 333 is one in which information processing by software (stored in the storage 32) is concretely realized by hardware (the controller 33). The position measurement unit 333 is configured to measure the position of the front vehicle based on the difference D calculated by the histogram generation unit 332, as well as the first histogram HG1 and the second histogram HG2. The measured position of the front vehicle may be presented to the driver of the automobile via a monitor (not shown) as appropriate. Furthermore, an appropriate control signal may be transmitted to an automatic controller for automatically controlling (automatically driving) the automobile based on the measurement result.

[Correction Unit 334]

The correction unit 334 is one in which information processing by software (stored in the storage 32) is concretely realized by hardware (the controller 33). The correction unit 334 estimates the correspondence of coordinates of the first IPM image IM1′ and the second IPM image IM2′ by comparing these two, and corrects the error of the IPM image IM′ from the true value based on the estimated correspondence of the coordinates. More details will be described in Section 4.

2. Inverse Perspective Projection Transportation

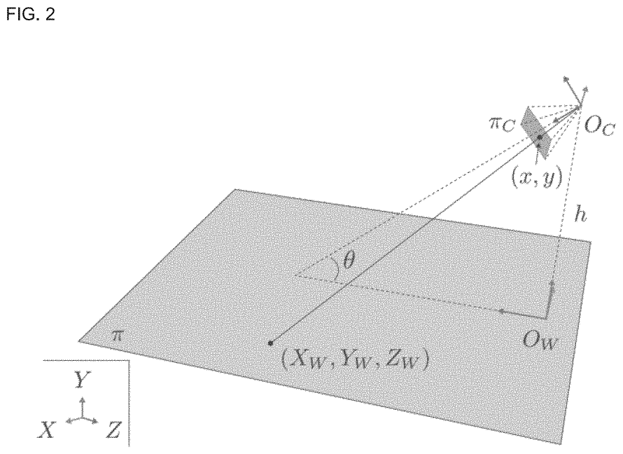

In Section 2, the inverse perspective projection transportation will be described. FIG. 2 is a schematic view of the inverse perspective projection transportation. Note that a pinhole camera is assumed as the model here, and a formula is made considering only a pitch angle of the camera. Of course, a fisheye camera or an omnidirectional camera may be assumed, and the formular may be made in consideration of a roll angle. As shown in FIG. 2, a point (x, y) when a point (X_W, Y_W, Z_W) represented by a world coordinate system O_W is projected onto a camera image plane π_C is represented as [Equation 1].

$$λ [ \begin{matrix}x \\ y \\ 1\end{matrix} ] = K Π [ \begin{matrix} & & & \\ & R & & T \\ & & & \\ & 0 & & 1\end{matrix} ] [ \begin{matrix}{X}_{W} \\ {Y}_{W} \\ {Z}_{W} \\ 1\end{matrix} ] \qquad [ Equation 1 ]$$

Note that, K is an internal matrix of the cameras (the first camera 21 and the second camera 22), Π is a projection matrix from the camera coordinate system O_C to the camera image plane π_C, and R∈SO(3) and T∈RA3 are a rotation matrix and a translation vector from the world coordinate system O_W to the camera coordinate system O_C, respectively.

Now, consider the case where the objects captured by the first camera 21 and the second camera 22 exist only on the plane π. In this case, since there is a one-to-one correspondence between the points on the image plane and the points on π, a one-to-one mapping from the image plane to π can be considered. This mapping is called Inverse Perspective Mapping. When R and T are each expressed as [Equation 2], the point (X_W, Y_W, Z_W) on π, the inverse perspective projection image of the point (x, y) on the image, is calculated as [Equation 3] by using (x, y).

$$\begin{matrix}R = [ \begin{matrix}1 & 0 & 0 \\ 0 & cos θ & sin θ \\ 0 & - sin θ & cos θ\end{matrix} ] , T = [ \begin{matrix}0 \\ - h cos θ \\ h sin θ\end{matrix} ] & [ Equation 2 ] \\ [ \begin{matrix}{X}_{W} \\ {Y}_{W} \\ {Z}_{W}\end{matrix} ] = [ \begin{matrix}- \frac{{hf}_{y} ( {o}_{x} - x )}{{f}_{x} ( {o}_{y} cos θ + {f}_{y} sin θ - y cos θ )} \\ \frac{h ( {f}_{y} cos θ - {o}_{y} sin θ + y sin θ )}{{o}_{y} cos θ + {f}_{y} sin θ - y cos θ}\end{matrix} ] & [ Equation 3 ]\end{matrix}$$

Here, f_x and f_y are focal lengths in the x and y directions, respectively, and (o_x, o_y) is an optical center. In the present embodiment, the image projected from the image IM captured by the imaging apparatus 2 by this mapping is referred to as the IPM image IM′. When two cameras (the first camera 21 and the second camera 22) are capturing the same plane, a calculated pair of IPM images IM′ (the first IPM image IM1′ and the second IPM image IM2′) has the same luminance of the pixel corresponding to one point on the plane. However, if there is an object present in the field of view that is not on the plane, there will be a difference in luminance within the pair of IPM images IM′. By detecting this difference (difference D), it is possible to detect the object present in the field of view. Since this method is robust to planar texture, it can accurately detect an object even in a situation where a monocular camera is not good at reflecting shadow.

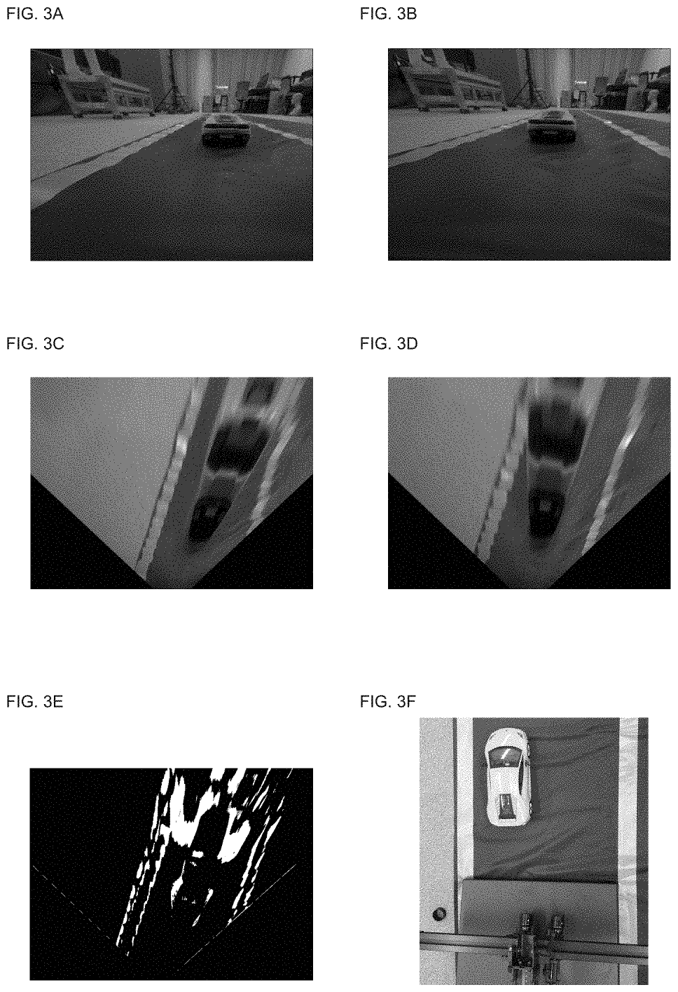

Specific examples are shown in FIGS. 3A to 3F. FIG. 3A shows the first image IM1 captured by the first camera 21 (left), and FIG. 3B shows the second image IM2 captured by the second camera 22 (right). FIG. 3C shows the first IPM image IM1′ obtained by converting the first image IM1, FIG. 3D shows the second IPM image IM2′ obtained by converting the second image IM2, and FIG. 3E shows the difference D (binarized with a predetermined threshold value) between the first IPM image IM1′ and the second IPM image IM2′. FIG. 3F shows an overhead view taken by another camera (not shown). By detecting the difference D shown in FIG. 3E, the position of the front vehicle in front (the part shown in white), which is the object, is measured.

3. Determination of Predetermined Area ROI

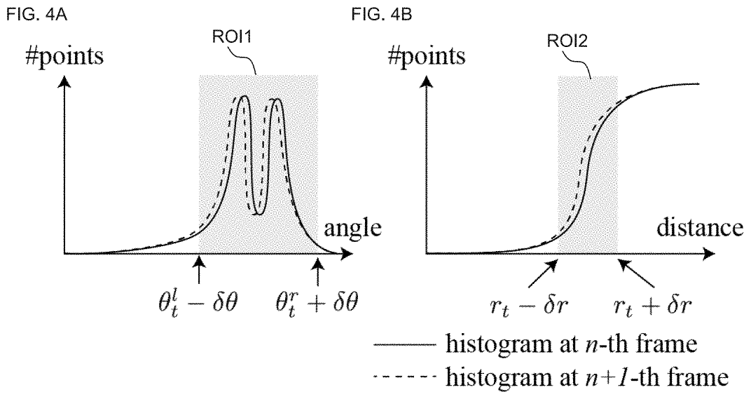

The predetermined ROI will be described in Section 3. When an object exists in the angle of view of the two cameras (the first camera 21 and the second camera 22), a large triangle-shaped non-zero area is formed in the difference D of the pair of IPM images IM′ corresponding to the left and right sides of the object, respectively (see FIG. 3E). When taking the first histogram HG1 which is a histogram HG in the angular direction with the origin at the midpoint F of the points where the two cameras are projected onto the plane (which is interpreted as the point where the imaging apparatus 2 is projected), then it has a peak at the position corresponding to the apex of the triangle, as shown in FIG. 4A. The angle showing this peak represents the angle from the camera to the side of the object. Here, a micro assumption of the amount of movement is made for this object. That is, when assuming that the angular movement of the object between successive frames is at most 60, then the relation in [Equation 4] is established between the peak position θ_(t+1) at time t+1 and the peak position θ_t at time t.

θₜ−δθ≤θₜ₊₁≤θₜ+δθ [Equation 4]

When taking the second histogram HG2, which is a histogram HG in the length direction centered at the midpoint F in the difference D, then it has a steep change in the part corresponding to the lower edge of the object, as shown in FIG. 4b. In the same way for the amount of movement in the length direction between the frames, when assuming that it is high δr, then the relationship in [Equation 5] is established between the peak position r_(t+1) at time t+1 and the peak position r_t at time t.

rₜ−δr≤rₜ₊₁≤rₜ+δr [Equation 5]

By employing the relationships expressed in [Equation 4] and [Equation 5], the first predetermined area ROI1 with respect to the first histogram HG1 and the second predetermined area ROI2 with respect to the second histogram HG2 can be limited (see FIGS. 4A and 4B). In particular, note that in the first histogram HG1 shown in FIG. 4A, since there are two peaks θ(θ\hat{ }l and θ\hat{ }r, respectively) as the two end parts of the object that is the front vehicle, the left end of the first predetermined area ROI1 becomes θ\hat{ }l(_t)−δθ and the right end becomes θ\hat{ }r(_t)+. In the next frame, after integrating them, it is only necessary to perform the inverse perspective projection transportation on the bounding box part of the predetermined area ROI where the histogram HG is taken, which can greatly streamline the calculation.

In other words, the reference parameter for the first histogram HG1 is an angle θ in a polar coordinate centered on the position of the imaging apparatus 2 in the IPM image IM′ (or more strictly, the difference D), and the reference parameter for the second histogram HG2 is a distance r in the polar coordinate. Further, based on whether or not the respective parameters (the angle θ and the distance r) in the first histogram HG1 and the second histogram HG2 are within the predetermined range, the predetermined area ROI is determined when generating the histogram HG in the next frame.

4. Correction

Correction (calibration) made by the correction unit 334 in the information processing apparatus 3 will be described in Section 4. With such a correction, the accuracy of the inverse perspective projection transportation can be improved.

4.1 Correction with a Monocular Camera

In the present embodiment, although the first camera 21 and the second camera 22 are comprised, the correction can be performed by each camera alone. In other words, the correction unit 334 is configured to estimate the parameters of the imaging apparatus 2 by successively comparing the current image and the past image, and to correct the error of the IPM image IM′ from the true value based on the estimated parameters.

Specifically, two images IM that were captured by a single camera and in different frames are compared. A plurality of points of interest are set in images IM, respectively, and a positioning algorithm is implemented. The camera external parameter {Θ} is estimated by reprojection error minimization, and the inverse perspective projection transportation is performed on the two images IM using the estimated camera external parameter {Θ} to obtain the two IPM images IM′.

Then, for the two IPM images IM′, a plurality of points of interest are set and a positioning algorithm is implemented in the same way as for the two images IM. The external camera parameter {Θ} is again estimated by reprojection error minimization. Then, using the estimated extrinsic camera parameters {Θ} again, the inverse perspective projection transportation is performed on the two IM images to obtain the two new IPM images IM′. After repeating the above processing, the external camera parameter {Θ} converges and the correction is completed. The converged values include the pitch angle, the roll angle, a translation amount of the camera itself (measurement system 1), and a rotation amount of the same. In this way, the correction of the imaging apparatus 2 for the inverse perspective projection transportation is made. In addition, three or more images may be used instead of two images IM, and the use of RANSAC, time series information, and Kalman filter may be implemented to remove the parts that failed to be estimated.

4.2 Correction with a Stereo Camera

In the present embodiment, since the first camera 21 and the second camera 22 are comprised, such a configuration can be used to ascertain the position and attitude relationship between the cameras and further make corrections. In other words, the correction unit 334 is configured to estimate the correspondence of these coordinates by comparing the first IPM image IM1′ and the second IPM image IM2′, and to correct the error of the IPM image IM′ with the true value based on the estimated correspondence of the coordinates. Based on the estimated correspondence of coordinates, the system is configured to correct the error of the IPM image IM′ from the true value.

Specifically, consider the case that the correction has been completed with the monocular camera as described in Section 4.1. First, as an initial setting, the first IPM image IM1′ and the second IPM image IM2′ are bordered by the predetermined area ROI that is preset, and the positioning algorithm is implemented to obtain the initial value of the translation amount among the translation and rotation amounts {Θ}.

The following is an iterative processing. the first IPM image IM1′ and the second IPM image IM2′ are bordered again by the predetermined area ROI using the obtained initial value of the translation amount, and the positioning algorithm is implemented to obtain the translation and rotation amount {Θ}. Then, a plurality of predetermined areas ROI in the IPM image IM′ are extracted based on the obtained amount of translation and rotation {Θ}, and the amount of translation and rotation θ_i is calculated for each of them. Then, it is confirmed whether the overall translation and rotation amount {Θ} and the translation and rotation amount {Θ}_i of each predetermined area ROI are consistent, and this is repeated until convergence is achieved. In this way, the correction of the imaging apparatus 2 related to the inverse perspective projection transportation is made.

4.3 Iterative Processing Using Optical Flow as an Indicator

In the iterative processing described above, more specifically, an optical flow calculated based on the frame (image IM) adjacent to the time series can be used as an indicator. The optical flow is a vector in which the starting point is an arbitrarily selected point at time t−1 and in which the ending point is a point that satisfies a predetermined condition (estimated destination) compared to the selected point at time t. The optical flow is commonly used as an indicator of the movement of an object in an image. In particular, it can be computed with low computational cost by using Lucas Kanade method. In particular, the optical flow can be estimated with high accuracy by using image alignment methods such as phase-limited correlation method on the IPM image IM′.

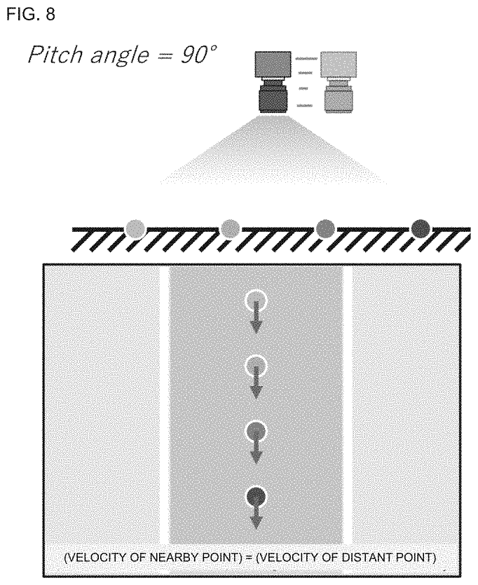

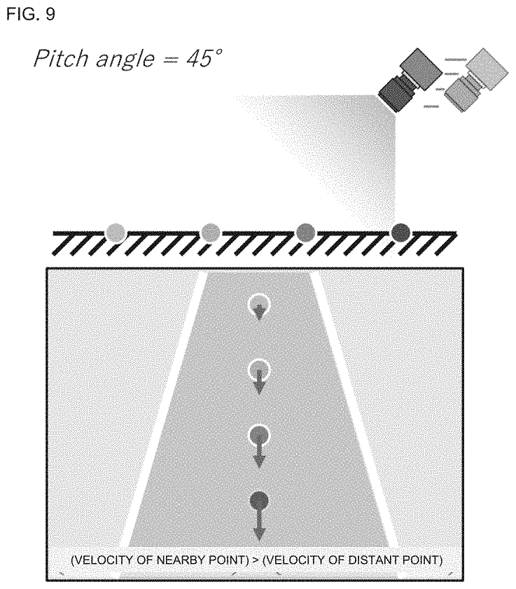

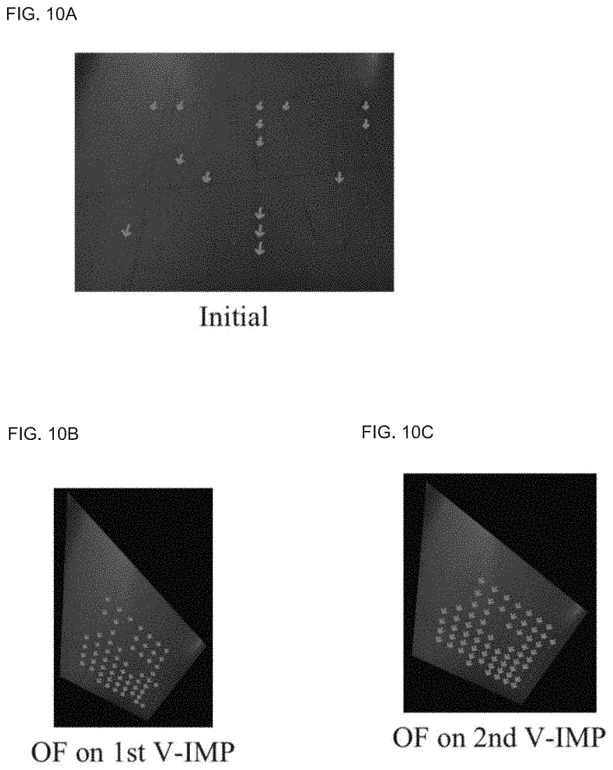

FIG. 8 and FIG. 9 are schematic views showing the relationship between the pitch angle of the camera and the movement (optical flow) of the feature point on the road surface. When comparing points close to the camera and points far from the camera, these optical flows are different depending on the pitch angle and the roll angle of the camera. Assuming that the IPM image IM′ is a pseudo-overhead image and the camera is translating, then the optical flow of each of the plurality of selected points in the IPM image IM′ will ideally be uniform. In other words, by iterating the processing so that the optical flow is uniform, the pitch angle, the roll angle, the translation of the camera itself (measurement system 1), and the rotation of the same can be obtained as convergence values. Specifically, see FIG. 10. FIG. 10 shows the comparison of the optical flow for the image IM before the IPM conversion processing (FIG. 10A), the optical flow obtained by the first IPM conversion processing (FIG. 10B), and the optical flow obtained by the second IPM conversion processing (FIG. 10C). In FIG. 10C, it is confirmed that the optical flow is more uniform than in FIG. 10B.

By realizing such an iterative processing at high velocity, the camera external parameter {Θ} can be obtained in real time. Therefore, by using this measurement system 1, it can be applied for motorcycles and drones in which the position and posture of the camera fluctuates.

5. Measurement Method

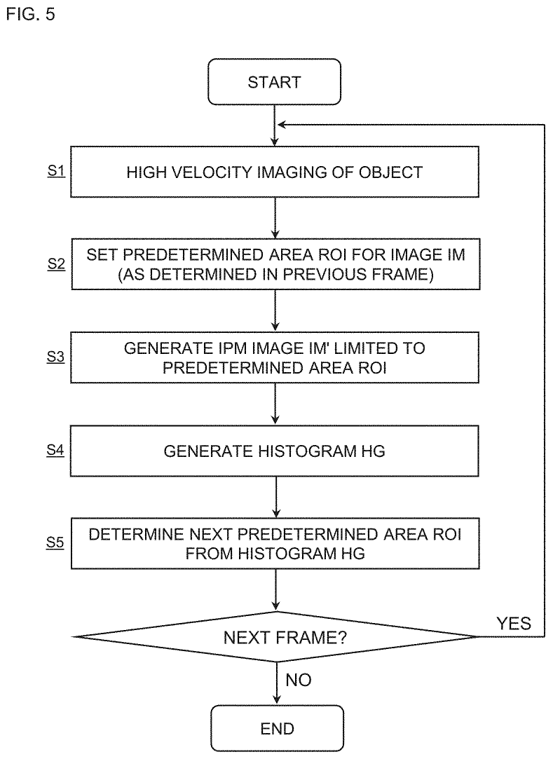

A measurement method using the measurement system 1 of the present embodiment will be described in Section 5. FIG. 5 is a flowchart showing the flow of the measurement method. Hereinafter, each step in FIG. 5 will be described.

[Start]

[Step S1]

At a certain time t, the imaging apparatus 2 (the first camera 21 and the second camera 22) captures the object as images IM (the first image IM1 and the second image IM2) at a frame rate of 100 fps or higher (continue to step S2).

(Step S2)

Then, a predetermined area ROI is set for the image IM captured in step S1. The predetermined area ROI here is determined in step S5 (described below) earlier than the time t (usually one frame before). However, for the first frame, such a predetermined area ROI may not have to be set (continue to step S3).

(Step S3)

Subsequently, the IPM conversion unit 331 performs an inverse perspective projection transportation (see Section 2) on the image IM, and generates IPM images IM′ (the first IPM image IM1′ and the second IPM image IM2′) limited to the predetermined area ROI set in step S2 (continue to step S4).

(Step S4)

Then, the histogram generation unit 332 calculates the difference D between the first IPM image IM1′ and the second IPM image IM2′, and subsequently generates histograms HG (the first histogram HG1 and the second histogram HG2) generated based on different parameters (angle and distance), respectively. Based on such difference D, the position measurement unit 333 will measure the position of the object (continue to step S5).

(Step S5)

Then, the histogram generation unit 332 determines the predetermined area ROI that can be set in step S2 (described above) after time t (usually one frame ahead) based on the histogram HG generated in step S4.

[End]

Note that by repeating steps S1 to S5 in this way, the position of the object is measured at a high operation rate. Although the description is omitted, it is preferable that the correction by the correction unit 334 described in Section 4 is performed during these steps. Furthermore, machine learning regarding the predetermined region ROI may be performed at any timing.

6. Variations

Variations related to the present embodiment will be described in Section 6. That is, the measurement system 1 according to the present embodiment may be further creatively devised according to the following aspects.

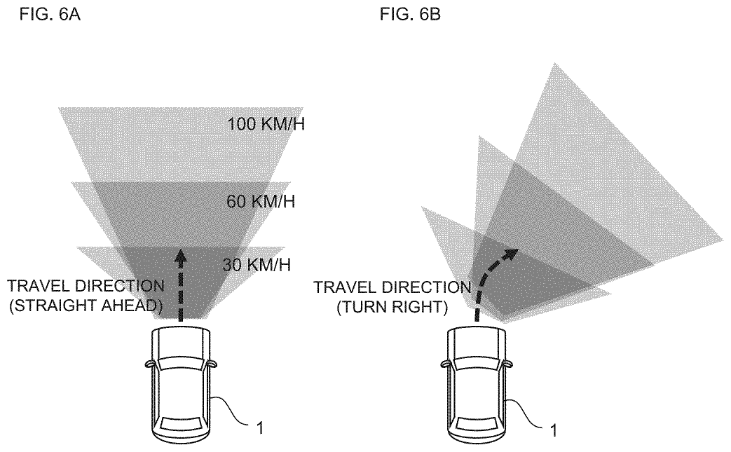

First, when the measurement system 1 is configured to be movable as in the automobile, the predetermined area ROI may be determined by considering at least one of velocity, acceleration, moving direction, and surrounding environment of the measurement system 1, as shown in FIGS. 6A and 6B. In particular, it is preferable that the correlation between these parameters and the predetermined area ROI is learned in advance by machine learning. In addition, it is preferable that the predetermined area ROI is determined more preferably by further machine learning while continuously using the measurement system 1.

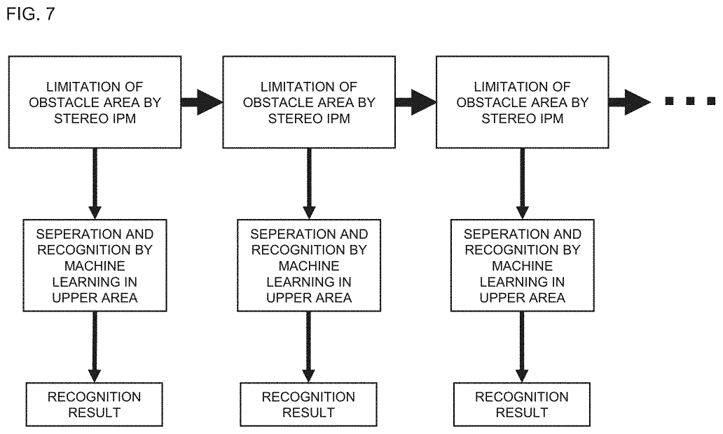

Second, when there is a plurality of objects that can be obstacles, it is preferable that the position measurement unit 333 in the information processing apparatus 3 is configured to separately recognize each of these plurality of objects. In particular, it is preferable that the position measurement unit 333 is configured to separately recognize each of the plurality of objects by having the predetermined area ROI enclosing each of the plurality of objects learned in advance by machine learning. Further, as shown in FIG. 7, it is preferable that the accuracy of the separation is further improved by sequentially performing machine learning of the predetermined area ROI while continuously using the measurement system 1 and repeating the recognition of the objects using the inverse perspective projection transportation described above. In this way, the positions, types, and the like of various objects included in the predetermined area ROI can be specified. In particular, it is preferable to estimate the distance to the object based on the value of the lower edge of the bounding box surrounding the object and height, the roll angle, and the pitch angle of the imaging apparatus 2. Alternatively, if the imaging apparatus 2 is binocular as in the measurement system 1 regarding the present embodiment, it may be implemented to measure the distance to the object by stereo vision.

Third, for instance, if the automobile is equipped with the measurement system 1, an automatic operation may be performed for a part or all of the objects based on the measured positions of the objects. For example, braking or steering to avoid a collision may be considered. It may also be implemented so that a recognition status of the measured object is displayed on a monitor installed in the automobile so that the driver of the automobile can recognize it.

Fourth, in the aforementioned embodiment, although the two-lens imaging apparatus 2 comprises the first camera 21 and the second camera 22 is used, a three-lens or more imaging apparatus 2 using three or more cameras may be implemented. By increasing the number of cameras, it is capable to improve the robustness related to the measurements made by the measurement system 1. It should also be noted that the correction by the correction unit 334 described in Section 4.2 can be applied in the same way for three or more lens.

Fifth, the imaging apparatus 2 and the information processing apparatus 3 may be realized not as a measurement system 1, but as a single apparatus having these functions. Specifically, for instance, a 3D measurement device, an image processing device, a projection display device, a 3D simulator device, or the like.

7. Conclusion

As described above, according to the present embodiments, it is possible to implement the measurement system 1 that can realize safe operations in industry by quickly and reliably detecting the presence of objects (obstacles) to be measured.

The measurement system 1 is configured to measure the position of an object, and is equipped with an imaging apparatus 2 and an information processing apparatus 3. The imaging apparatus 2 is a camera (first camera 21 and second camera 22) with a frame rate of 100 fps or higher, and is configured to capture the object included in the angle of view of the camera as an image IM. The information processing apparatus 3 is configured to be able to capture the object included in the angle of view of the camera as an image IM, and the information processing apparatus 3 is equipped with a communication unit 31, an IPM conversion unit 331, and a position measurement unit 333, the communication unit 31 is connected to the image pickup device 2 and is configured to be able to receive the image IM captured by the image pickup device 2, and the IPM conversion unit 331 is able to convert at least a part of the image IM including the object into a predetermined area RO The IPM conversion unit 331 is configured to set at least a part of the image IM including the object as a predetermined area ROI, and to generate an IPM image IM′ limited to the predetermined area ROI by inverse perspective projection conversion of the image IM. wherein the IPM image IM′ is an image drawn in such a way that it overlooks a predetermined plane including the object, and the position measurement unit 333 is configured to be able to measure the position of the object based on the IPM image IM′.

In addition, by using such a measurement system 1, it is possible to implement a measurement method that can realize safe operations in industry by quickly and reliably detecting the presence of objects (obstacles) to be measured.

The measurement method for measuring position of an object, comprising: an imaging step of capturing the object included in the angle of view of cameras (the first camera 21 and the second camera 22) as image IM by using the camera with a frame rate of 100 fps or higher; an IPM conversion step of determining at least a part of the image including the object as the predetermined area ROI, and performs inverse perspective projection transportation on the image IM to generate the IPM image IM′ limited to the predetermined area ROI, the IPM image IM′ being an image drawn as an overhead view of the predetermined plane including the object; and a position measurement step of measuring position of the object based on the IPM image IM′.

The software for implementing the measurement system 1 as hardware, which can realize safe operation in industry by quickly and reliably detecting the presence of objects (obstacles) to be measured, can also be implemented as a program. Such a program may be provided as non-transitory computer readable medium that can be read by a computer, may be provided for download from an external server, or may be provided as a so-called cloud computing so as to start the program on an external computer and realized each function thereon.

Such a measurement program for measuring the position of the object is configured to cause a computer to execute an image capturing function, an IPM conversion function, and a position measurement function, wherein: with the image capturing function, the object included in the angle of view of cameras (the first camera 21 and the second camera 22) is captured as an image IM at a frame rate of 100 fps or higher, with the IPM conversion function, at least a part of the image IM including the object is determined as the predetermined area ROI, and the image IM is inverse perspective projection transported to generate an IPM image IM′ limited to the predetermined area ROI, here the IPM image IM′ is an image drawn as an overhead view of the predetermined plane including the object, and with the position measurement function, the position of the object is measured based on the IPM image IM′.

It may be provided in each of the following aspects.

The measurement system, wherein: assuming that the image related to the n-th (n≥2) frame captured by the imaging apparatus is a current image, and the image related to the n-k-th (n>k≥1) frame captured by the imaging apparatus is a past image, then the predetermined area applied to the current image is set based on the past position of the object measured using the past image.

The measurement system, wherein: the information processing apparatus further comprises a correction unit configured to estimate parameters of the imaging apparatus by successively comparing the current image with the past image, and configured to correct error from a true value of the IPM image based on the parameters estimated.

The measurement system, wherein: the imaging apparatus is a binocular imaging apparatus including first and second cameras, and is configured to capture the object included in the angle of view of the first and second cameras as first and second images at the frame rate, the IPM conversion unit is configured to generate first and second IPM images corresponding to the first and second images, and the position measurement unit is configured to measure the position of the object based on the difference between the first and second IPM images.

The measurement system, wherein: the information processing apparatus further comprises a correction unit, configured to estimate correspondence relation between coordinates of the first and second IPM images by comparing the first and second IPM images, and configured to correct error from the true value of the IPM image based on the estimated correspondence relation of the coordinates.

The measurement system, further comprising: a histogram generation unit configured to generate a histogram limited to the predetermined area based on the difference of the IPM image.

The measurement system, wherein: the histogram is a plurality of histograms including first and second histograms generated based on different parameters, and the predetermined area is determined based on whether or not each of the parameters is in a predetermined range.

The measurement system, wherein: the parameters that serve as reference for the first histogram are angles in polar coordinates centered on the position of the imaging apparatus in the IPM image, and the parameters that serve as reference for the second histogram are distances in the polar coordinate.

The measurement system, wherein: the measurement system is configured to be movable, and the predetermined area is determined based on at least one of velocity, acceleration, moving direction, and surrounding environment of the measurement system.

The measurement system, further configured to learn the correlation between at least one of velocity, acceleration, moving direction and surrounding environment of the measurement system, and the predetermined area by machine learning.

The measurement system, wherein: the object is a plurality of objects, and the position measurement unit is configured to separately recognize each of the plurality of objects and to measure the positions of each of the objects.

The measurement system, further configured to learn a result of separately recognizing the plurality of objects by machine learning, thereby configured to improve the accuracy of the separate recognition by the position measurement unit through continuous use of the measurement system.

A measurement method for measuring position of an object, comprising: an imaging step of capturing the object included in an angle of view of a camera as an image by using the camera with a frame rate at least equal to 100 fps; an IPM conversion step of determining at least a part of the image including the object as a predetermined area, and performs inverse perspective projection transportation on the image to generate an IPM image limited to the predetermined area, the IPM image being an image drawn as an overhead view of the predetermined plane including the object; and a position measurement step of measuring position of the object based on the IPM image.

An information processing apparatus of a measurement system configured to measure position of an object, comprising: a reception unit configured to receive an image including the object; an IPM conversion unit configured to set at least a part of the image including the object as a predetermined area, and to perform inverse perspective projection transportation on the image to generate an IPM image limited to the predetermined area, the IPM image being an image drawn as an overhead view of the predetermined plane including the object; and a position measurement unit configured to measure position of the object based on the IPM image.

A measurement program, wherein: the measurement program is a computer to function as an information processing apparatus according to claim 14.

Of course, the above embodiments are not limited thereto.

Finally, various embodiments of the present invention have been described, but these are presented as examples and are not intended to limit the scope of the invention. The novel embodiment can be implemented in various other forms, and various omissions, replacements, and changes can be made without departing from the abstract of the invention. The embodiment and its modifications are included in the scope and abstract of the invention and are included in the scope of the invention described in the claims and the equivalent scope thereof.

1. A measurement system configured to measure a position of an object, comprising:
an imaging apparatus and an information processing apparatus, wherein:
the imaging apparatus
is a camera with a frame rate, and
is configured to capture the object included in an angle of view of the camera as an image; and
the information processing apparatus includes:
a communication unit, connected to the imaging apparatus, and configured to receive the image captured by the imaging apparatus,
an IPM conversion unit, configured to set at least a part of the image including the object as a predetermined area, and to perform inverse perspective projection transportation on the image to generate an IPM image limited to the predetermined area, the IPM image being an image drawn as an overhead view of the predetermined planes including the object, and
a position measurement unit configured to measure position of the object based on the IPM image.

2. The measurement system according to claim 1, wherein:
assuming that the image related to the n-th (n≥2) frame captured by the imaging apparatus is a current image, and the image related to the n-k-th (n>k≥1) frame captured by the imaging apparatus is a past image, then
the predetermined area applied to the current image is set based on the past position of the object measured using the past image.

3. The measurement system according to claim 2, wherein:
the information processing apparatus further comprises a correction unit
configured to estimate parameters of the imaging apparatus by successively comparing the current image with the past image, and
configured to correct error from a true value of the IPM image based on the parameters estimated.

4. The measurement system according to claim 1, wherein:
the imaging apparatus
is a binocular imaging apparatus including first and second cameras, and
is configured to capture the object included in the angle of view of the first and second cameras as first and second images at the frame rate,
the IPM conversion unit is configured to generate first and second IPM images corresponding to the first and second images, and
the position measurement unit is configured to measure the position of the object based on the difference between the first and second IPM images.

5. The measurement system according to claim 4, wherein:
the information processing apparatus further comprises a correction unit,
configured to estimate correspondence relation between coordinates of the first and second IPM images by comparing the first and second IPM images, and
configured to correct error from the true value of the IPM image based on the estimated correspondence relation of the coordinates.

6. The measurement system according to claim 4, further comprising:
a histogram generation unit configured to generate a histogram limited to the predetermined area based on the difference of the IPM image.

7. The measurement system according to claim 6, wherein:
the histogram is a plurality of histograms including first and second histograms generated based on different parameters, and
the predetermined area is determined based on whether or not each of the parameters is in a predetermined range.

8. The measurement system according to claim 7, wherein:
the parameters that serve as reference for the first histogram are angles in polar coordinates centered on the position of the imaging apparatus in the IPM image, and
the parameters that serve as reference for the second histogram are distances in the polar coordinate.

9. The measurement system according to claim 1, wherein:
the measurement system is configured to be movable, and
the predetermined area is determined based on at least one of velocity, acceleration, moving direction, and surrounding environment of the measurement system.

10. The measurement system according to claim 9,
further configured to learn the correlation between at least one of velocity, acceleration, moving direction and surrounding environment of the measurement system, and the predetermined area by machine learning.

11. The measurement system according to claim 1, wherein:
the object is a plurality of objects, and
the position measurement unit is configured to separately recognize each of the plurality of objects and to measure the positions of each of the objects.

12. The measurement system according to claim 11,
further configured to learn a result of separately recognizing the plurality of objects by machine learning, thereby configured to improve the accuracy of the separate recognition by the position measurement unit through continuous use of the measurement system.

13. A measurement method for measuring position of an object, comprising:
an imaging step of capturing the object included in an angle of view of a camera as an image by using the camera with a frame rate of 100 fps or higher;
an IPM conversion step of determining at least a part of the image including the object as a predetermined area, and performs inverse perspective projection transportation on the image to generate an IPM image limited to the predetermined area, the IPM image being an image drawn as an overhead view of the predetermined plane including the object; and
a position measurement step of measuring position of the object based on the IPM image.

14. An information processing apparatus of a measurement system configured to measure position of an object, comprising:
a reception unit configured to receive an image including the object;
an IPM conversion unit configured to set at least a part of the image including the object as a predetermined area, and to perform inverse perspective projection transportation on the image to generate an IPM image limited to the predetermined area, the IPM image being an image drawn as an overhead view of the predetermined plane including the object; and
a position measurement unit configured to measure position of the object based on the IPM image.

15. A non-transitory computer readable media storing a measurement program, wherein:
the non-transitory computer readable media storing the measurement program is a computer to function as an information processing apparatus according to claim 14.
